(19) United States
(12) Patent Application Publication
(10) Pub. No.: US 2025/0201819 A1
(43) Pub. Date: Jun. 19, 2025

(54) SILICON-CARBON-CONTAINING ELECTRODE MATERIAL AND LITHIUM SECONDARY BATTERY INCLUDING THE SAME

(71) Applicants: SK INNOVATION CO., LTD., Seoul (KR); SK ON CO., LTD., Seoul (KR)

(72) Inventors: Hee Soo KIM, Daejeon (KR); Yeon Ho KIM, Daejeon (KR); Young Kwang KIM, Daejeon (KR); Young Eun CHEON, Daejeon (KR); Joon Hyung MOON, Daejeon (KR); Hye Jin PARK, Daejeon (KR)

(21) Appl. No.: 18/979,605

(22) Filed: Dec. 13, 2024

(30) Foreign Application Priority Data
Dec. 14, 2023 (KR) 10-2023-0182283

(51) Int. Cl. H01M 4/36; C01B 32/05; H01M 4/02; H01M 4/38; H01M 4/587; H01M 10/052

(52) U.S. Cl. CPC H01M 4/366; C01B 32/05; H01M 4/386; H01M 4/587; H01M 10/052; C01P 2002/82; C01P 2004/80; C01P 2006/12; C01P 2006/14; C01P 2006/40; H01M 2004/021; H01M 2004/027

(57) ABSTRACT

A silicon-carbon-containing electrode material including a porous carbon structure and a silicon-containing coating layer formed on the porous carbon structure. A volume ratio of micropores in the porous carbon structure having a pore diameter of 2 nm or less in a total pore volume is greater than 50% and less than 90%. A lithium secondary battery comprising the anode which comprises the silicon-carbon-containing electrode material and a cathode disposed to face to the anode. The lithium secondary battery employing the silicon-containing electrode exhibits improved lifespan and efficiency characteristics.

### CROSS REFERENCE TO RELATED APPLICATION

The present application claims priority to Korean Patent Application No. 10-2023-0182283, filed on Dec. 14, 2023, the entire contents of which are incorporated by reference herein for all purposes.

### BACKGROUND OF THE INVENTION

### 1. Field of the Invention

The embodiments of the present disclosure relate to a silicon-carbon-containing electrode material and a lithium secondary battery including the same. More specifically, the embodiments relate to a silicon-carbon-containing electrode material which include a porous carbon material, and a lithium secondary battery including the silicon-carbon-containing electrode material.

### 2. Description of the Related Art

A secondary battery is a battery which can be repeatedly charged and discharged. With rapid progress of information and communication, and display industries, the secondary battery has been widely applied to various portable electronic telecommunication devices such as a camcorder, a mobile phone, a laptop computer as a power source thereof. In addition, a battery pack including the secondary battery has also been developed and applied to an eco-friendly automobile such as a hybrid vehicle as a power source thereof.

Examples of the secondary battery may include a lithium secondary battery, a nickel-cadmium battery, a nickel-hydrogen battery and the like. Among them, the lithium secondary battery has a high operating voltage and a high energy density per unit weight, and is advantageous in terms of a charging speed and light weight.

For example, the lithium secondary battery may include: an electrode assembly including a cathode, an anode, and a separator (e.g., a separation membrane), and an electrolyte in which the electrode assembly is impregnated. The lithium secondary battery may further include, for example, a pouch-shaped outer case in which the electrode assembly and the electrolyte are housed.

Recently, in order to manufacture a lithium secondary battery having higher capacity and output, substantial research and development efforts are focusing on combining silicon and carbon as an anode material. It is postulated that the silicon may improve the capacity characteristics of the battery, while the carbon may serve as support for the silicon.

### SUMMARY

An embodiment of the present disclosure provides an improved silicon-carbon-containing electrode material exhibiting improved lifespan and efficiency characteristics.

Another embodiment of the present disclosure provides a method for manufacturing the silicon-carbon-containing electrode material.

Further, another embodiment of the present disclosure provides a lithium secondary battery comprising the silicon-carbon-containing electrode material and exhibiting improved lifespan and efficiency characteristics.

According to an embodiment of the present disclosure, there is provided a silicon-carbon-containing electrode material including a porous carbon structure, and a silicon-containing coating layer formed on the porous carbon structure. A volume ratio of micropores in the porous carbon structure having a pore diameter of 2 nm or less in a total pore volume is greater than 50% and less than 90%. Stated differently, between 50% and 90% of the total pore volume is made of micropores having a pore diameter of 2 nm or less.

In some embodiments, the volume ratio of micropores in the porous carbon structure having a pore diameter of 2 nm or less in the total pore volume may be 55% to 80%.

In some embodiments, the volume ratio of mesopores having a pore diameter of greater than 2 nm and less than 50 nm in the total pore volume may be 8% to 48%, and the volume ratio of macropores having a pore diameter of greater than 50 nm may be 1.5% to 10%.

In some embodiments, the total pore volume may be 0.02 cm³/g to 0.2 cm³/g.

In some embodiments, a ratio of the total pore volume of the electrode material to a total pore volume of the porous carbon structure may be 0.15 or less.

In some embodiments, the electrode material may have a specific surface area of 60 m²/g to 320 m²/g.

In some embodiments, a ratio of a specific surface area of the electrode material to a specific surface area of the porous carbon structure may be 0.1 or less.

In some embodiments, a content of silicon in the total weight of the electrode material may be 30% by weight to 80% by weight.

In some embodiments, a peak intensity ratio of Raman spectral spectrum measured from the silicon-containing coating layer defined by Formula 1 below may be 0.5 or less:

$$Peak intensity ratio of Raman spectral spectrum = {I}_{c - Si} / {I}_{a - Si} . \qquad [ Formula 1 ]$$

In Formula 1, I_{c-Si} may be a peak intensity of the silicon-containing coating layer in a region where a wavelength may be 515 nm⁻¹ in the Raman spectral spectrum, and I_{a-Si} may be a peak intensity of the silicon-containing coating layer in a region where the wavelength is 480 nm⁻¹ in the Raman spectral spectrum).

In some embodiments, a ratio of a peak intensity (I_{D}) in a D band to a peak intensity (I_{G}) in a G band of the Raman spectral spectrum obtained from the porous carbon structure may be 1 to 1.3.

In addition, according to another embodiment of the present invention, there is provided a method for preparing a silicon-carbon-containing electrode material. In the method, a polymer precursor solution may be prepared. A polymer gel may be formed by polymerizing a polymer precursor included in the polymer precursor solution. A bulk carbon structure may be formed by drying and carbonizing the polymer gel. Porous carbon structures may be formed by pulverizing the bulk carbon structure. A silicon-containing coating layer may be deposited on the porous carbon structures to obtain a silicon-carbon-containing electrode material. A volume ratio of micropores in the porous carbon structure having a pore diameter of 2 nm or less in a total pore volume of the electrode material may be greater than 50% and less than 90%.

In some embodiments, the silicon-containing coating layer may be formed through a deposition process under conditions of a temperature of 400° C. to 800° C. and a pressure of 700 torr to 800 torr.

In some embodiments, the deposition process may include supplying a silicon precursor and a carrier gas, and a ratio of a flow rate of the silicon precursor to a flow rate of the carrier gas may be 1/50 to 1/3.

Further, according to another embodiment of the present invention, there is provided a lithium secondary battery including an anode which includes the silicon-carbon-containing electrode material according to the above-described embodiments; and a cathode disposed to face to the anode.

The silicon-carbon-containing electrode material according to various embodiments may include a porous carbon structure and a silicon-containing coating layer formed on the porous carbon structure.

In the electrode material, a volume ratio of micropores in the porous carbon structure having a pore diameter of 2 nm or less in a total pore volume may be greater than 50% and less than 90%. Accordingly, contact between the silicon and the electrolyte may be minimized, thereby improving lifespan characteristics and efficiency of the lithium secondary battery.

The electrode material may be widely applied to green technology fields such as an electric vehicle, and a battery charging station, as well as other solar power generation and wind power generation using the batteries. In addition, the lithium secondary battery may be used in an eco-friendly electric vehicle, and a hybrid vehicle, etc., which are intended to prevent climate change by suppressing air pollution and greenhouse gas emissions.

### BRIEF DESCRIPTION OF THE DRAWINGS

The above and other objects, features and other advantages of the embodiments of the present disclosure will be more clearly understood from the following detailed description taken in conjunction with the accompanying drawings, in which:

FIGS. 1 and 2 are a schematic plan view and a cross-sectional view illustrating a lithium secondary battery according to an embodiment of the present disclosure, respectively;

FIG. 3 is a flowchart illustrating procedures of a method for manufacturing a silicon-carbon-containing electrode material according to an embodiment of the present disclosure;

FIGS. 4 to 8 are graphs illustrating pore distributions of silicon-carbon-containing electrode materials according to Examples 1 to 5, respectively; and

FIGS. 9 to 14 are graphs illustrating pore distributions of silicon-carbon-containing electrode materials according to Comparative Examples 1 to 6, respectively.

### DETAILED DESCRIPTION

Embodiments of the present disclosure provide a silicon-carbon-containing electrode material including a porous carbon structure and a silicon-containing coating layer formed on the porous carbon structure. Moreover, an anode for a lithium secondary battery and a lithium secondary battery including the electrode material are provided.

According to some embodiments, the electrode material may be used as an anode material of a lithium secondary battery. However, it should be understood that the use of the electrode material is not limited to the anode material, and may be used as a material having conductivity or charge storage characteristics of various electric, electronic, and electrochemical devices.

As these terms are used herein, micropore refers to a pore having a diameter of 0.01 nm to 2 nm, mesopore refers to a pore having a diameter of greater than 2 nm and less than 50 nm, and macropore refers to a pore having a diameter of greater than 50 nm.

Hereinafter, embodiments of the present disclosure will be described in detail. However, these embodiments are merely examples, and the scope of the present disclosure is not limited only to the described embodiments.

### Silicon-Carbon-Containing Electrode Material

The silicon-carbon-containing electrode material according to various embodiments includes a porous carbon structure and a silicon-containing coating layer formed on the porous carbon structure. A volume ratio of micropores in the porous carbon structure having a pore diameter of 2 nm or less in the total pore volume may be greater than 50% and less than 90%.

In some embodiments, the porous carbon structure may include a carbonized polymer. In some embodiments, the porous carbon structure may be, for example, a carbide material. A carbonized polymer refers to a material created by converting a polymer into a carbon-rich structure through a process called carbonization which involves heating the polymer in the absence of oxygen, which removes non-carbon elements and leaves behind a carbonized residue. A carbide material may be composed of carbon and a metal of metalloid element. Examples of carbide materials include tungsten carbide (WC), silicon carbide (SiC), and titanium carbide (TIC).

In some embodiments, the porous carbon structure may include a plurality of pores. The pores may be formed from the surface of the porous carbon structure and then extend to an inside of the porous carbon structure.

For example, a cross-section of the porous carbon structure may be formed in a circular shape or may be randomly changed from the circular shape. The silicon-containing coating layer may be partially formed on the pores and the surface of the porous carbon structure as a plurality of discontinuous islands or patterns.

In some embodiments, the porous carbon structure may have a total pore volume of 0.8 cm³/g to 1.2 cm³/g, 0.85 cm³/g to 1.1 cm³/g, 0.9 cm³/g to 1.05 cm³/g, or 0.95 cm³/g to 1 cm³/g. Within the above range, a sufficient silicon-containing coating layer may be formed inside the pores, and the capacity characteristics of the battery may be improved.

In some embodiments, the porous carbon structure may have a specific surface area of 650 m²/g to 2200 m²/g, 1200 m²/g to 2150 m²/g, 1700 m²/g to 2100 m²/g, or 1800 m²/g to 2100 m²/g. Within the above range, the stability of the electrode material may be improved while sufficiently securing a silicon deposition area.

In some embodiments, the silicon-containing coating layer may be formed on the surface of the porous carbon structure. For example, the silicon-containing coating layer may be formed together on an outer surface of the porous carbon structure and an inner surface of the pores.

In some embodiments, the pores of the porous carbon structure described above may be at least partially filled with the silicon-containing coating layer. For example, the pores may be completely or partially filled with the silicon-containing coating.

When the pores are partially filled with the silicon-containing coating, an internal space of the pores may further include a residual space except for the portion filled with the silicon-containing coating layer.

In some embodiments, the silicon-containing coating layer may be formed through a deposition process (e.g., a chemical vapor deposition (CVD) process).

For example, a silicon precursor may be supplied to the porous carbon structure in which the above-described pores are formed. Silicon grains separated from the silicon precursor may be deposited on the porous carbon structure to form the silicon-containing coating layer.

For example, the silicon grains may be deposited on an outer wall of the porous carbon structure, as well as may also be substantially uniformly deposited on an inner wall of the pores. Accordingly, a silicon-containing coating layer having a uniform profile may be formed throughout the entire surface of the porous carbon structure.

When a ratio of pores filled with the silicon-containing coating layer among the pores included in the porous carbon structure is increased, the increased specific surface area through the pores may be sufficiently utilized to improve the capacity characteristics of the battery.

For example, the electrode material may include micropores and may further include mesopores and macropores.

In some embodiments, the volume ratio of micropores in the porous carbon structure having a pore diameter of 2 nm or less in the total pore volume of the electrode material may be greater than 50% and less than 90%. For example, the volume ratio of micropores in the total pore volume of the electrode material may be 50.5% to 80%, 55% to 80%, 55% to 75%, 55% to 70%, or 55% to 60%.

When the volume ratio of micropores in the total pore volume of the electrode material is 50% or less, the contact between silicon and the electrolyte may be increased, thereby causing an increase in the formation of a solid electrolyte interface (SEI). Accordingly, the electrolyte may be depleted, and initial efficiency and lifespan characteristics of the lithium secondary battery may be deteriorated.

When the volume ratio of micropores in the total pore volume of the electrode material is 90% or more, it is difficult for the silicon precursor to be deposited on the inner wall of the pores in the porous carbon structure, and condensation between the silicon precursors on the outer surface of the porous carbon structure may occur, thereby causing an agglomeration of the silicon grains. Accordingly, the capacity characteristics of the battery may be deteriorated.

In some embodiments, the volume ratio of mesopores having a pore diameter greater than 2 nm and 50 nm or less in the total pore volume of the electrode material may be 8% to 48%, for example, 15% to 48%, 20% to 45%, 30% to 40%, or 30% to 35%.

In some embodiments, the volume ratio of macropores having a pore diameter greater than 50 nm in the total pore volume of the electrode material may be 1.5% to 10%, for example, 1.7% to 9.9%, 2.0% to 9.8%, 2.5% to 9.7%, or 3% to 9.5%.

Within the above-described range of the volume ratio of the mesopores and the volume ratio of the macropores, the silicon-containing coating layer may be sufficiently formed inside the pores included in the porous carbon structure, and the aggregation of the silicon grains may be suppressed. Accordingly, the capacity characteristics of the lithium secondary battery may be improved.

In some embodiments, the total pore volume of the electrode material may be 0.02 cm³/g to 0.2 cm³/g, for example, 0.03 cm³/g to 0.16 cm³/g, 0.04 cm³/g to 0.10 cm³/g, or 0.04 cm³/g to 0.06 cm³/g.

Within the above range, an occurrence of cracks due to excessive increase in the pore volume may be prevented.

In some embodiments, a ratio of the total pore volume of the electrode material to a total pore volume of the porous carbon structure may be 0.15 or less, for example, 0.1 or less, 0.01 to 0.15, or 0.01 to 0.1. Within the above range, the specific surface area of the electrode material may be sufficiently secured.

In some embodiments, the specific surface area of the electrode material may be 60 m²/g to 320 m²/g, for example, 61 m²/g to 200 m²/g, 62 m²/g to 180 m²/g, or 62 m²/g to 100 m²/g. Within the above range, a uniform silicon-containing coating layer may be formed throughout the entire surface of the porous carbon structure.

In some embodiments, the ratio of the specific surface area of the electrode material to the specific surface area of the porous carbon structure may be 0.1 or less, for example, 0.05 or less, 0.01 to 0.1, or 0.01 to 0.05. Within the above range, silicon may be uniformly deposited into the pores of the porous carbon structure.

For example, the above-described total pore volume and the distribution (volume ratio) of the micropores, mesopores, and macropores may be measured using nitrogen gas adsorption/desorption according to the standards specified in ISO 15901-2 and ISO 15901-3.

The porosity and pore diameter distribution of the material may be specified by condensing a nitrogen gas in the pores of the solid through nitrogen gas adsorption. As the pressure is increased, the nitrogen gas may be first condensed in the pores having the smallest diameter, and the pressure may be increased until it reached a saturation point where all the pores are filled with liquid. Thereafter, the nitrogen gas pressure may be gradually reduced to evaporate the liquid from the system. The pore volume and pore distribution may be measured by analyzing the nitrogen adsorption and desorption isotherms and the hysteresis therebetween.

For example, the above-described specific surface area may refer to a surface area per unit mass calculated by measuring the physical adsorption of gas molecules on a solid surface using the Brunauer-Emmett-Teller (BET) theory according to the ISO 9277 standard.

In some embodiments, a content of the silicon in the total weight of the electrode material may be 30% by weight (“wt %”) to 80 wt %, for example, 40 wt % to 76 wt %, 48.5 wt % to 70 wt %, or 50 wt % to 60 wt %. Accordingly, the stability and energy density of the electrode material may be improved.

In some embodiments, a peak intensity ratio of the Raman spectral spectrum measured from the silicon-containing coating layer defined by Equation 1 below may be 0.5 or less, for example, 0.4 or less. Within the above range, an amorphous structure ratio of the silicon may be increased, thereby improving the structural stability of the electrode material.

$$Peak intensity ratio of Raman spectral spectrum = {I}_{c - Si} / {I}_{a - Si} \qquad Equation 1$$

In Equation 1, I_{c-Si} may be a peak intensity of the silicon-containing coating layer in a region where a wavelength is 515 nm⁻¹ in the Raman spectral spectrum, and I_{a-Si} may be a peak intensity of the silicon-containing coating layer in a region where the wavelength is 480 nm⁻¹ in the Raman spectral spectrum.

For example, I_{c-Si} in Equation 1 may represent a specific gravity of silicon having a crystalline structure (Crystalline-Si), and I_{a-Si} in Equation 1 may represent a specific gravity of silicon having an amorphous structure (Amorphous-Si).

In some embodiments, a ratio of a peak intensity I_{D} in a D band to a peak intensity I_{G} in a G band of the Raman spectral spectrum obtained from the porous carbon structure may be 1 to 1.3, for example, 1.05 to 1.25, 1.1 to 1.25, 1.15 to 1.22, or 1.2 to 1.22. Within the above range, defects in the carbonaceous material may be decreased, thereby improving the stability of the electrode material.

In the Raman spectral spectrum obtained by Raman spectroscopy of the porous carbon structure, the peak intensity I_{G} in the G band may be the peak intensity for a wavenumber range of about 1540 cm⁻¹ to about 1620 cm⁻¹, and the peak intensity I_{D} in the D band may be the peak intensity for a wavenumber range of about 1300 cm⁻¹ to about 1420 cm⁻¹.

The G band is a peak that can be commonly found in graphite-based materials, and may appear, for example, when carbon atoms forming a hexagonal structure exist. The D band is caused by a vibration mode with symmetry and is not observed in a perfect lattice structure, and may appear, for example, when the hexagonal structure is not widely developed or when there is a defect.

For example, the above-described ratio of the peak intensity I_{D} in the D band to the peak intensity I_{G} in the G band may be an average value of values obtained through Raman spectroscopy from 3 to 100 points by selecting a partial area in the carbon, and may vary depending on changes in the thickness, uniformity, and structural stability of the carbon-based material.

The Raman spectroscopy may be performed using the type of Raman spectrometer known in the art. For example, a laser wavelength of the Raman spectrometer may be, for example, about 532 nm to about 785 nm, a laser power may be about 5 mW to about 90 mW, a laser exposure time may be about 3 seconds to about 20 seconds, and the number of scans may be 1 to 10.

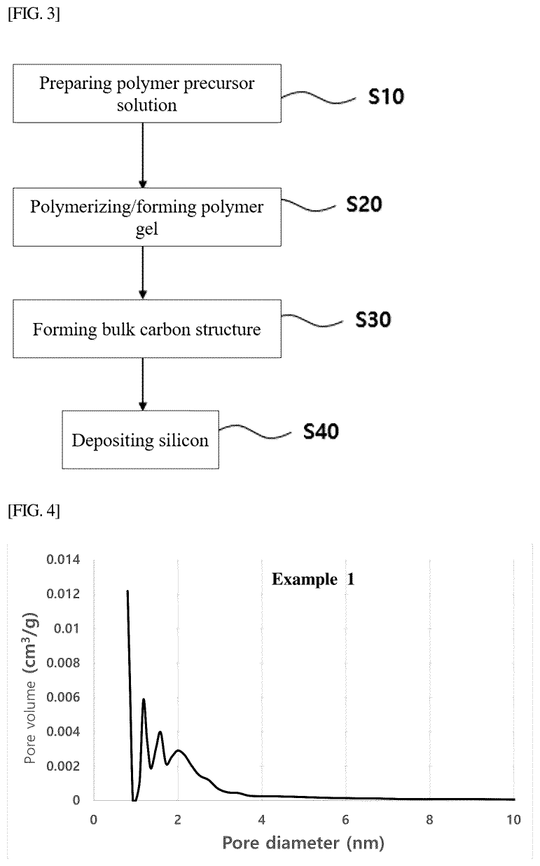

FIG. 3 is a flowchart illustrating procedures of a method for manufacturing a silicon-carbon-containing electrode material according to an embodiment of the present disclosure.

Referring to FIG. 3, for example, in operation S10, a polymer precursor solution may be prepared. A polymer precursor solution may exist in a sol state, meaning that the polymer precursor has solid particles dispersed within the liquid solvent.

For example, a polymer precursor for matrix formation in the porous carbon structure may be dissolved in a polar solvent such as water or a protic solvent. The polymer precursor may include an amine group-containing compound, an alcohol compound, a carbonyl group-containing compound, etc.

For example, the polymer precursor may include a phenol compound, polyalcohol, alkyl amine, aromatic amine, an aldehyde compound, a ketone compound, a carboxylic acid compound, an ester compound, urea, an acid halide, an isocyanate compound, etc. These may be used alone or in combination of two or more thereof.

In some embodiments, a first precursor and a second precursor, which are different from each other, may be used together as the polymer precursor. For example, the first precursor may include a phenol compound and the second precursor may include an aldehyde compound. In some embodiments, the first precursor may include resorcinol and the second precursor may include formaldehyde.

In some embodiments, a molar ratio of the second precursor to the first precursor may be adjusted in a range of 1 to 3, for example, in a range of 1 to 2.5 or 1 to 2.

For example, in operation S20, a polymer gel may be formed by performing polymerization in the polymer precursor solution. Gelation means that the dispersed polymer particles of the polymer precursor link up with one another to form a continuous network.

According to various embodiments, a polymerization catalyst and/or a polymerization initiator may be added into the polymer precursor solution to perform a polymerization reaction. Accordingly, a polymer gel may be formed while a polymer is generated in the solution.

In some embodiments, the polymerization catalyst may include an alkaline compound. For example, the polymerization catalyst may include a hydroxide of alkaline metal or alkaline earth metal; a carbonate of alkaline metal or alkaline earth metal; an ammonium compound such as ammonium carbonate, ammonium bicarbonate, ammonium acetate, or ammonium hydroxide; an amine compound such as diethylamine, triethylamine, triethanolamine, ethylenediamine, hexamethylenetetramine, etc. These may be used alone or in combination of two or more thereof.

The molar ratio of the phenol compound (e.g., resorcinol) as the first precursor to the polymerization catalyst may be adjusted in a range of 100 to 1,000, for example, 150 to 700, 150 to 600, 150 to 500, 200 to 700, 200 to 600, or 200 to 500.

For example, the polymerization initiator may include azobisisobutyronitrile (AIBN), t-butyl peracetate, benzoyl peroxide (BPO), acetyl peroxide, lauroyl peroxide, etc.

A polymerization temperature for forming the polymer gel may be in a range of about 70° C. to 100° C., and a polymerization time may be 1 day to 4 days or 2 days to 3 days.

For example, in operation S30, a bulk carbon structure may be formed through drying and carbonization.

According to various embodiments, a solvent (e.g., water) in the polymer gel may be removed through drying, and pores may be formed in the space where the solvent is removed. The dried polymer may be carbonized to form a bulk carbon structure including the pores.

In some embodiments, the carbonization may be performed under anaerobic conditions or inert gas (e.g., N₂ or Ar) conditions. The carbonization may be performed at a temperature of 700° C. or higher, and for example, may be performed at a temperature of 800° C. to 1200° C., 800° C. to 1100° C., or 850° C. to 1,000° C.

In some embodiments, the bulk carbon structure may be pulverized to form a plurality of porous carbon structures.

For example, in operation S40, silicon may be deposited on the porous carbon structures to form a silicon-containing coating layer, thereby obtaining a silicon-carbon-containing electrode material.

In some embodiments, the silicon-containing coating layer may be formed through a chemical vapor deposition (CVD) process or a physical vapor deposition (PVD) process using a silicon precursor. The silicon precursor may include a silane compound (e.g., SiH₄).

For example, in the case of the CVD process, the silicon precursor may be supplied together with a carrier gas such as N₂ and/or Ar.

In some embodiments, a ratio of a flow rate of the silicon precursor to a flow rate of the carrier gas may be 1/50 to 1/3, for example, 1/20 to 1/3 or 1/10 to 1/3. Within the above range, the silicon coating may easily be formed without causing pore blockage.

In some embodiments, the flow rate of the silicon precursor may be adjusted according to an amount of the porous carbon structure loaded into a deposition chamber.

For example, the silicon precursor may be injected so that a space velocity (SV) defined by Equation 2 below is maintained in an appropriate range.

$$SV ( {h}^{- 1} ) = \frac{Silicon precursor volumetric flow rate ( cc / h )}{Carbon volume ( cc )} \qquad Equation 2$$

In equation 2, the carbon volume may be calculated through a density of the porous carbon structure.

For example, the space velocity (SV) of the silicon precursor may be 100 h⁻¹ to 3000 h⁻¹, 500 h⁻¹ to 3000 h⁻¹, or 750 h⁻¹ to 2500 h⁻¹. Within the above range, the silicon deposition efficiency may be improved depending on the amount of the porous carbon structure loaded into the deposition chamber.

In some embodiments, the CVD process may be performed at a temperature range of 400° C. to 800° C. For example, the CVD process may be performed at a temperature range of 425° C. to 750° C., or 425° C. to 700° C.

In some embodiments, the CVD process may be performed at a pressure range of 700 torr to 800 torr. For example, the CVD process may be performed at a pressure range of 720 torr to 780 torr, or 740 torr to 780 torr.

In some embodiments, the CVD process may be performed for 1000 to 2000 minutes. For example, the CVD process may be performed for 1200 to 1950 minutes, 1300 to 1900 minutes, 1400 to 1850 minutes, or 1500 to 1800 minutes.

In some embodiments, the electrode material may be manufactured to have characteristics such as micropore volume ratio, mesopore volume ratio, macropore volume ratio, total pore volume, specific surface area, etc. in the above-described ranges.

According to various embodiments, the above-described characteristics may be acquired by adjusting a combination of conditions including the flow rate and space velocity (SV) of the silicon precursor, deposition temperature, deposition pressure, deposition time, etc.

For example, in the electrode material, a volume ratio of micropores in the porous carbon structure having a pore diameter of 2 nm or less in the total pore volume may be greater than 50% and less than 90%.

In some embodiments, a carbon coating may be further formed on the silicon-containing coating layer. The carbon coating may be formed through deposition using a gas such as methane or solution coating using a monomer/polymer solution.

In some embodiments, the carbon coating may include a polymer having improved elastic properties, such as an acrylonitrile polymer, and may also include, for example, a conductive polymer such as polypyrrole, polyaniline, polythiophene, poly 3,4-ethylenedioxythiophene, etc.

In some embodiments, the carbon coating may be formed by high-temperature decomposing or polymerizing a hydrocarbon precursor, for example, alkanes such as methane, ethane or propane, alkenes such as ethylene or propylene, or alkynes such as acetylene in an inert gas or anaerobic atmosphere.

### Lithium Secondary Battery

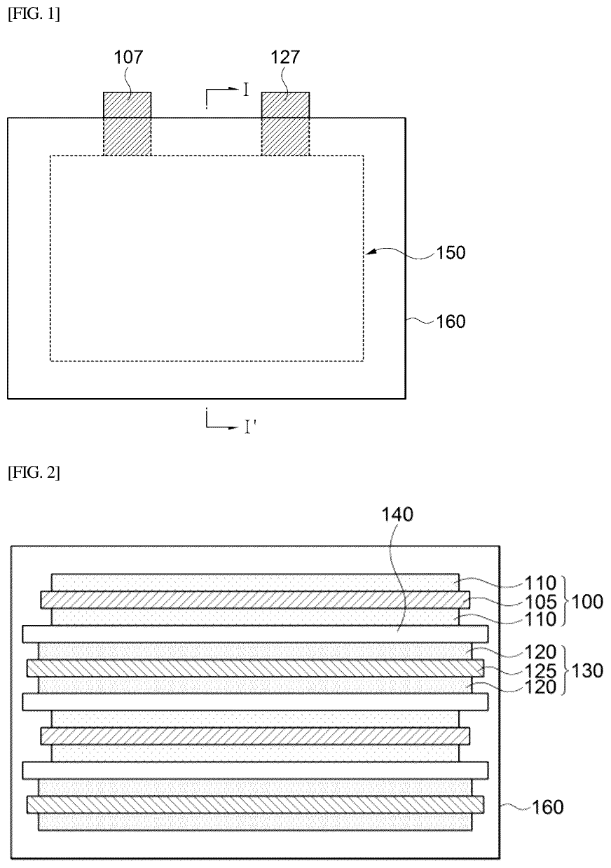

FIGS. 1 and 2 are a schematic plan view and a cross-sectional view illustrating the lithium secondary battery according to an embodiment of the present disclosure, respectively. Specifically, FIG. 2 is a cross-sectional view taken on line I-I′ in FIG. 1.

Referring to FIGS. 1 and 2, the lithium secondary battery may include an electrode assembly including a cathode 100 and an anode 130. The electrode assembly 150 may further include a separation membrane 140 interposed between the cathode 100 and the anode 130. The electrode assembly 150 may be housed in a case 160 together with an electrolyte solution including an electrolyte and may be impregnated with the electrolyte solution.

The cathode 100 may include a cathode current collector 105 and a cathode active material layer 110 disposed on at least one surface of the cathode current collector 105.

For example, the cathode current collector 105 may include stainless steel, nickel, aluminum, titanium, or an alloy thereof. The cathode current collector may also include aluminum or stainless steel subjected to surface treatment with carbon, nickel, titanium, or silver. The cathode current collector may have a thickness of 10 μm to 50 μm, for example, but it is not limited thereto.

For example, the cathode active material may include a compound capable of reversibly intercalating and deintercalating lithium ions.

For example, the cathode active material may include a lithium metal oxide including a metal element such as nickel, cobalt, manganese, aluminum, etc.

According to various embodiments, the cathode active material may include a lithium-nickel metal oxide. The lithium-nickel metal oxide may further include at least one of cobalt (Co), manganese (Mn) and aluminum (Al).

In some embodiments, the cathode active material or the lithium-nickel metal oxide may include a layered structure or a crystal structure represented by Formula 1 below.

LiₓNiₐM_{b}O_{2+z} Formula 1

In Formula 1, x, a, b and z may be in a range of 0.95≤x≤1.2, 0.6≤a≤0.99, 0.01≤b≤0.4, −0.5≤z≤0.1, respectively. As described above, M may include Co, Mn, and/or Al.

The chemical structure represented by Formula 1 indicates a bonding relationship between elements included in the layered structure or crystal structure of the cathode active material, and does not exclude other additional elements. For example, M includes Co and/or Mn, and Co and Mn may be provided as main active elements of the cathode active material together with Ni. Here, it should be understood that Formula 1 is provided to express the bonding relationship between the main active elements, and is a formula encompassing introduction and substitution of the additional elements.

In some embodiments, the inventive material may further include auxiliary elements which are added to the main active elements, thus to enhance chemical stability of the cathode active material or the layered structure/crystal structure. The auxiliary element may be incorporated into the layered structure/crystal structure together to form a bond, and it should be understood that this case is also included within the chemical structure represented by Formula 1.

The auxiliary element may include at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P or Zr, for example. The auxiliary element may act as an auxiliary active element which contributes to the capacity/output activity of the cathode active material together with Co or Mn like Al.

For example, the cathode active material or the lithium-nickel metal oxide may include a layered structure or a crystal structure represented by Formula 1-1 below.

LiₓNiₐM_{b1}M_{b2}O_{2+z} Formula 1-1

In Formula 1-1, M1 may include Co, Mn, and/or Al. M2 may include the auxiliary elements described above. In Formula 1-1, x, a, b and z may be in a range of 0.95≤x≤1.2, 0.6≤a≤0.99, 0.01≤b1+b2≤0.4, −0.5≤z≤0.1, respectively.

The cathode active material may further include a coating element or a doping element. For example, elements which are substantially the same as or similar to the above-described auxiliary elements may be used as the coating element or the doping element. For example, the above-described elements may be used alone or in combination of two or more thereof as the coating element or the doping element.

The coating element or the doping element may exist on the surface of the lithium-nickel metal oxide particles, or may penetrate through the surface of the lithium-nickel metal oxide particles to be included in the bonding structure represented by the Formula 1 or Formula 1-1 above.

The cathode active material may include a nickel-cobalt-manganese (NCM)-based lithium oxide. In this case, an NCM-based lithium oxide with an increased content of nickel may be used.

Nickel may be provided as a transition metal related to the output and capacity of the lithium secondary battery. Therefore, as described above, by employing a high-content (High-Ni) composition in the cathode active material, a high-capacity cathode and a high-capacity lithium secondary battery may be provided.

However, as the content of Ni is increased, long-term storage stability and life-span stability of the cathode or the secondary battery may be relatively decreased, and a side reaction with the electrolyte may also be increased. However, according to various embodiments, the life-span stability and capacity retention characteristics may be improved through Mn while maintaining electrical conductivity by including Co.

The content of Ni (e.g., a mole fraction of nickel based on the total moles of nickel, cobalt and manganese) in the NCM-based lithium oxide may be 0.6 or more, 0.7 or more, or 0.8 or more. In some embodiments, the Ni content may be 0.8 to 0.95, 0.82 to 0.95, 0.83 to 0.95, 0.84 to 0.95, 0.85 to 0.95, or 0.88 to 0.95.

In some embodiments, the cathode active material may include a lithium cobalt oxide-based active material, a lithium manganese oxide-based active material, a lithium nickel oxide-based active material, or a lithium iron phosphate (LFP)-based active material (e.g., LiFePO₄).

In some embodiments, the cathode active material may include a manganese (Mn)-rich active material, a lithium rich layered oxide (LLO)/over lithiated oxide (OLO)-based active material, or a cobalt (Co)-less active material, which have a chemical structure or crystal structure represented by Formula 2 below.

p[Li₂MnO₃]·(1−p)[LiqJO₂] Formula 2

In Formula 2, p and q are in a range of 0<p<1, 0.9≤q≤1.2, respectively, and J may include at least one element among Mn, Ni, Co, Fe, Cr, V, Cu, Zn, Ti, Al, Mg and B.

For example, the cathode active material may be dispersed in a solvent to prepare a cathode slurry. The cathode current collector 105 may be coated with the cathode slurry, and then dried and pressed to prepare the cathode 100. The coating process may be performed by a method such as gravure coating, slot die coating, simultaneous multilayer die coating, imprinting, doctor blade coating, dip coating, bar coating or casting, etc., but it is not limited thereto. The cathode slurry may further include a binder, and optionally further include a conductive material, a thickener or the like.

Non-limiting examples of a solvent used in the preparation of the cathode slurry may include N-methyl-2-pyrrolidone (NMP), dimethylformamide, dimethylacetamide, N,N-dimethylaminopropylamine, ethylene oxide, tetrahydrofuran and the like.

The binder may include polyvinylidene fluoride (PVDF), poly(vinylidene fluoride-co-hexafluoropropylene), polyacrylonitrile, polymethylmethacrylate, acrylonitrile butadiene rubber (NBR), polybutadiene rubber (BR), styrene-butadiene rubber (SBR) and the like. In some embodiments, a PVDF-based binder may be used as the cathode binder.

The conductive material may be added to enhance the conductivity of the cathode slurry layer and/or the mobility of lithium ions or electrons. For example, the conductive material may include a carbon-based conductive material such as graphite, carbon black, acetylene black, Ketjen black, graphene, carbon nanotubes (CNTs), vapor-grown carbon fibers (VGCFs), carbon fibers, and/or a metal-based conductive material including tin, tin oxide, titanium oxide, or a perovskite material such as LaSrCoO₃, and LaSrMnO₃.

As the thickener, for example, carboxymethyl cellulose (CMC) may be used.

The anode 130 may include an anode current collector 125 and an anode active material layer 120 on the anode current collector 125.

For example, the anode active material layer 120 may include an anode active material and an anode binder, and may further include a conductive material.

For example, the anode 130 may be prepared by mixing and stirring the anode active material, the anode binder, the conductive material, etc. in a solvent to prepare an anode slurry, and then coating the anode current collector 125 with the anode slurry, followed by drying and pressing the same.

The coating process may be performed by a method such as gravure coating, slot die coating, simultaneous multilayer die coating, imprinting, doctor blade coating, dip coating, bar coating or casting, etc., but it is not limited thereto.

For example, the anode current collector 125 may include gold, stainless steel, nickel, aluminum, titanium, copper, or an alloy thereof, and may include copper or a copper alloy as an example. In some embodiments, the anode current collector may have a thickness of 10 μm to 50 μm, however, the embodiments are not limited thereto.

For example, the anode active material layer 120 may include a silicon-carbon-containing electrode material according to the above-described embodiments as the anode active material. In some embodiments, the anode active material may further include a graphite-based active material such as artificial graphite or natural graphite.

In some embodiments, a content of the silicon-carbon-containing electrode material according to the above-described embodiments in the total weight of the anode active material included in the anode active material layer 120 may be 5 wt % or more, 10 wt % or more, 20 wt % or more, 30 wt % or more, 40 wt % or more, or 50 wt % or more, 95 wt % or less, 90 wt % or less, 80 wt % or less, or 70 wt % or less.

In some embodiments, the anode active material included in the anode active material layer 120 may be composed of the content of the silicon-carbon-containing electrode material according to the above-described embodiments. Thereby, the initial efficiency, capacity characteristics, and lifespan characteristics of the lithium secondary battery may be improved.

For example, the content of the anode active material included in the anode active material layer 120 may be 60 wt % to 99 wt % based on the total weight of the anode active material layer 120, for example, 70 wt % to 98 wt % or 80 wt % to 98 wt %.

Non-limiting examples of the anode mixture solvent may include water, pure water, deionized water, distilled water, ethanol, isopropanol, methanol, acetone, n-propanol, t-butanol and the like.

The anode binder and the conductive material may be substantially the same as or similar to the above-described cathode binder and conductive material.

For example, as the anode binder, a styrene-butadiene rubber (SBR)-based binder, a polyacrylic acid-based binder, a poly(3,4-ethylenedioxythiophene, PEDOT)-based binder, etc., may be used, which may be used together with a thickener such as carboxymethyl cellulose (CMC).

In some embodiments, the separation membrane 140 may be interposed between the cathode 100 and the anode 130. The separation membrane may prevent electrical short-circuit between the cathode and the anode, and maintain flow of ions. According to some embodiments, the separation membrane may have a thickness of 10 μm to 20 μm, however, the embodiments are not limited thereto.

For example, the separation membrane 140 may include a porous polymer film made of a polyolefin polymer, such as an ethylene polymer, a propylene polymer, an ethylene/butene copolymer, an ethylene/hexene copolymer, and an ethylene/methacrylate copolymer, etc.

For example, the separation membrane 140 may include a nonwoven fabric formed of glass fibers having a high melting point, polyethylene terephthalate fibers and the like.

For example, an electrode cell may be formed by including the cathode 100, the anode 130 and the separation membrane 140. In addition, a plurality of electrode cells may be stacked to form an electrode assembly 150. For example, the electrode assembly 150 may be formed by winding, stacking, z-folding, or stack-folding of the separation membrane 140.

The electrode assembly 150 may be housed in the case 160 together with the electrolyte to define a lithium secondary battery. According to various embodiments, a non-aqueous electrolyte may be used as the electrolyte.

The non-aqueous electrolyte includes a lithium salt of an electrolyte and an organic solvent, the lithium salt is represented by, for example, Li⁺X⁻; and as an anion (X⁻) of the lithium salt, F, Cl, Br, I, NO₃⁻, N(CN)₂⁻, BF₄, ClO₄⁻, PF₆⁻, (CF₃)₂PF₄⁻, (CF₃)₃PF₃⁻, (CF₃)PF₂⁻, (CF₃)₅PF⁻, (CF₃)₆P⁻, CF₃SO₃⁻, CF₃CF₂SO₃, (CF₃SO₂)₂N⁻, (FSO₂)₂N⁻; CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻; SCN⁻ and (CF₃CF₂SO₂)₂N⁻, etc. may be used.

The organic solvent may include an organic compound which has sufficient solubility to the lithium salt and the additive, and does not have reactivity in the battery. For example, the organic solvent may include at least one of a carbonate solvent, an ester solvent, an ether solvent, a ketone solvent, an alcohol solvent and an aprotic solvent.

As the organic solvent, for example, propylene carbonate (PC), ethylene carbonate (EC), butylene carbonate, diethyl carbonate (DEC), dimethyl carbonate (DMC), ethyl methyl carbonate (EMC), methylpropyl carbonate, ethylpropyl carbonate, dipropyl carbonate, vinylene carbonate, methyl acetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfur oxide, acetonitrile, diethoxyethane, sulfolane, gamma-butyrolactone, and propylene sulfite, and the like may be used. These may be used alone or in combination of two or more thereof.

The non-aqueous electrolyte may further include an additive, such as, for example, a cyclic carbonate compound, a fluorine-substituted carbonate compound, a sultone compound, a cyclic sulfate compound, a cyclic sulfite compound, a phosphate compound, a borate compound and the like.

The cyclic carbonate compound may include vinylene carbonate (VC), vinyl ethylene carbonate (VEC), and the like.

The fluorine-substituted carbonate compound may include, for example, fluoroethylene carbonate (FEC).

The sultone compound may include, for example, 1,3-propane sultone, 1,3-propene sultone, and 1,4-butane sultone.

The cyclic sulfate compound may include, for example, 1,2-ethylene sulfate, 1,2- and propylene sulfate.

The cyclic sulfite compound may include, for example, ethylene sulfite, butylene sulfite, and the like.

The phosphate compound may include, for example, lithium difluoro bis-oxalato phosphate, lithium difluoro phosphate, and the like.

The borate compound may include, for example, lithium bis(oxalate) borate, and the like.

As shown in FIG. 1, electrode tabs (a cathode tab and an anode tab) may protrude from the cathode current collector 105 and the anode current collector 125, respectively, which belong to each electrode cell, and may extend to one side of the case 160. The electrode tabs may be fused together with the one side of the case to form electrode leads (a cathode lead 107 and an anode lead 127) extending or exposed to an outside of the case 160.

The lithium secondary battery may be manufactured, for example, in a cylindrical shape using a can, a square shape, a pouch type or a coin shape.

Hereinafter, experimental examples including specific examples and comparative examples are proposed to facilitate understanding of the embodiments of the present disclosure. However, the following examples are only given for illustrating the embodiments and those skilled in the art will understand that various alterations and modifications are possible within the scope and spirit of the present disclosure. Such alterations and modifications are duly included in the appended claims. Furthermore, the embodiments may be combined to form additional embodiments.

### Example 1

### Formation of Silicon-Containing Coating Layer

As described in Table 1 below, a silicon-containing coating layer was formed on a porous carbon structure through a CVD process using SiH₄ as a precursor, by utilizing a carbon structure having an average pore size of 1.9 nm, a specific surface area of 2,052 m²/g, and a total pore volume of 0.98 cm³/g.

Specifically, as described above, the carbon structure was loaded into a CVD chamber, and the CVD process was performed under conditions of temperature 425° C., pressure 760 torr, LHSV of 31.5 h⁻¹, SiH₄/N₂ volume ratio of 0.02 considering a ratio of SiH₄ and carbon structure and deposition time of 1,800 minutes, thus to prepare a silicon-carbon-containing electrode material.

### Preparation of Anode

70 wt % of the silicon-carbon-containing electrode material prepared as described above as an anode active material, 15 wt % of SuperP as a conductive material, and 15 wt % of polyacrylic acid (PAA) as a binder were mixed to obtain an anode slurry. SuperP is a type of conductive carbon black available from TIMCAL subsidiary of Imerys S.A. a French multinational.

A copper substrate was coated with the anode slurry, then dried and pressed to prepare an anode having a slurry density of 1.5 g/cc.

### Manufacture of Lithium (Li) Half-Cell

A lithium secondary battery including the anode prepared by the above-described method and using lithium (Li) metal as a counter electrode (cathode) was manufactured.

Specifically, a lithium coin half-cell was formed by interposing a separation membrane (polyethylene, thickness: 20 μm) between the prepared anode and the lithium metal (thickness: 1 mm).

### Example 2

Utilizing the same carbon structure as in Example 1, a silicon-containing coating layer was formed on the porous carbon structure through a CVD process using SiH₄ as a precursor.

Specifically, as described above, the carbon structure was loaded into a CVD chamber, and the CVD process was performed under conditions of temperature 410° C., pressure 760 torr, LHSV of 0.11 h⁻¹, SiH₄/N₂ volume ratio of 0.15 considering a ratio of SiH₄ and carbon structure, and deposition time of 1,800 minutes, thus to prepare a silicon-carbon-containing electrode material.

A secondary battery was manufactured according to the same procedures as described in Example 1, except that the silicon-carbon-containing electrode material prepared by the above-described method was used.

### Example 3

Utilizing the same carbon structure as in Example 1, a silicon-containing coating layer was formed on the porous carbon structure through a CVD process using SiH₄ as a precursor.

Specifically, as described above, the carbon structure was loaded into a CVD chamber, and the CVD process was performed under conditions of temperature 410° C., pressure 760 torr, LHSV of 0.11 h⁻¹, SiH₄/N₂ volume ratio of 0.3 considering a ratio of SiH₄ and carbon structure, and deposition time of 1,800 minutes, thus to prepare a silicon-carbon-containing electrode material.

A secondary battery was manufactured according to the same procedures as described in Example 1, except that the silicon-carbon-containing electrode material prepared by the above-described method was used.

### Example 4

Utilizing the same carbon structure as in Example 1, a silicon-containing coating layer was formed on the porous carbon structure through a CVD process using SiH₄ as a precursor.

Specifically, as described above, the carbon structure was loaded into a CVD chamber, and the CVD process was performed under conditions of temperature 350° C., pressure 760 torr, LHSV of 0.11 h⁻¹, SiH₄/N₂ volume ratio of 0.11 considering a ratio of SiH₄ and carbon structure, and deposition time of 2,520 minutes, thus to prepare a silicon-carbon-containing electrode material.

A secondary battery was manufactured according to the same procedures as described in Example 1, except that the silicon-carbon-containing electrode material prepared by the above-described method was used.

### Example 5

Utilizing the same carbon structure as in Example 1, a silicon-containing coating layer was formed on the porous carbon structure through a CVD process using SiH₄ as a precursor.

Specifically, as described above, the carbon structure was loaded into a CVD chamber, and the CVD process was performed under conditions of temperature 370° C., pressure 760 torr, LHSV of 0.11 h⁻¹, SiH₄/N₂ volume ratio of 0.12 considering a ratio of SiH₄ and carbon structure, and deposition time of 2,160 minutes, thus to prepare a silicon-carbon-containing electrode material.

A secondary battery was manufactured according to the same procedures as described in Example 1, except that the silicon-carbon-containing electrode material prepared by the above-described method was used.

### Comparative Example 1

### Preparation of Porous Carbon Structure

A polymer precursor solution was prepared by mixing resorcinol and formaldehyde in water in a molar ratio of 1:2. The resorcinol and formaldehyde mixture and water were mixed in a weight ratio of 1:10. Sodium carbonate as a catalyst was added to the polymer precursor solution. The molar ratio of resorcinol to the catalyst was adjusted to 500. Thereafter, polymerization was performed at 80° C. for 3 days to form a polymer gel.

After polymerization, the polymer gel was completely dried at 60° C. or lower, and then carbonized at a temperature of 850° C. in an N₂ atmosphere. The carbonized product was pulverized to prepare a porous carbon structure.

### Formation of Silicon-Containing Coating Layer

Utilizing the manufactured carbon structure, a silicon-containing coating layer was formed on the porous carbon structure through a CVD process using SiH₄ as a precursor.

Specifically, as described above, the carbon structure was loaded into a CVD chamber, and the CVD process was performed under conditions of temperature 500° C., pressure 760 torr, LHSV of 20.0 h⁻¹, SiH/N₂ volume ratio of 0.1 considering a ratio of SiH₄ and carbon structure, and deposition time of 2,880 minutes, thus to prepare a silicon-carbon-containing electrode material.

A secondary battery was prepared in the same manner as in Example 1, except that the silicon-carbon-containing electrode material prepared by the above-described method was used.

### Comparative Example 2

A carbon structure manufactured in the same manner as Comparative Example 1 was used, and a silicon-containing coating layer was formed on the porous carbon structure through a CVD process using SiH₄ as a precursor.

Specifically, as described above, the porous carbon structure was loaded into a CVD chamber, and the CVD process was performed under conditions of temperature 390° C., pressure 760 torr, LHSV of 21.0 h⁻¹, SiH₄/N₂ volume ratio of 0.03 considering a ratio of SiH₄ and carbon structure, and deposition time of 2,160 minutes, thus to prepare a silicon-carbon-containing electrode material.

A secondary battery was manufactured in the same manner as Example 1, except that the silicon-carbon-containing electrode material prepared in the above-described manner was used.

### Comparative Example 3

Utilizing the same carbon structure used in Example 1, a silicon-containing coating layer was formed on the porous carbon structure through a CVD process using SiH₄ as a precursor.

Specifically, as described above, the carbon structure was loaded into a CVD chamber, and the CVD process was performed under conditions of temperature 350° C., pressure 760 torr, LHSV of 0.11 h⁻¹, SiH₄/N₂ volume ratio of 0.3 considering a ratio of SiH₄ and carbon structure, and deposition time of 2,520 minutes, thus to prepare a silicon-carbon-containing electrode material.

A secondary battery was manufactured in the same manner as Example 1, except that the silicon-carbon-containing electrode material prepared by the above-described method was used.

### Comparative Example 4

### Formation of Silicon-Containing Coating Layer

Utilizing a carbon structure having an average pore size of 4.0 nm, a specific surface area of 1,657 m²/g, and a total pore volume of 2.06 cm³/g as described in Table 1 below, a silicon-containing coating layer was formed on a porous carbon structure through a CVD process using SiH₄ as a precursor by.

Specifically, as described above, the carbon structure was loaded into a CVD chamber, and the CVD process was performed under conditions of temperature 500° C., pressure 760 torr, LHSV of 31.5 h⁻¹, SiH₄/N₂ volume ratio of 0.1 considering a ratio of SiH₄ and carbon structure, and deposition time of 600 minutes, thus to prepare a silicon-carbon-containing electrode material.

A secondary battery was manufactured according to the same procedures as described in Example 1, except that the silicon-carbon-containing electrode material prepared in the above-described manner was used.

### Comparative Example 5

Utilizing a carbon structure having an average pore size of 2.5 nm, a specific surface area of 1,729 m²/g, and a total pore volume of 1.12 cm³/g as described in Table 1 below, a silicon-containing coating layer was formed on the porous carbon structure through a CVD process using SiH₄ as a precursor.

Specifically, as described above, the carbon structure was loaded into a CVD chamber, and the CVD process was performed under conditions of temperature 500° C., pressure 760 torr, LHSV of 31.5 h⁻¹, SiH₄/N₂ volume ratio of 0.1 considering a ratio of SiH₄ and carbon structure, and deposition time of 600 minutes, thus to prepare a silicon-carbon-containing electrode material.

A secondary battery was manufactured according to the same procedures as described in Example 1, except that the silicon-carbon-containing electrode material prepared in the above-described manner was used.

### Comparative Example 6

Utilizing a carbon structure having an average pore size of 2.5 nm, a specific surface area of 1,729 m²/g, and a total pore volume of 1.12 cm³/g as described in Table 1 below, a silicon-containing coating layer was formed on the porous carbon structure through a CVD process using SiH₄ as a precursor.

Specifically, as described above, the carbon structure was loaded into a CVD chamber, and the CVD process was performed under conditions of temperature 500° C., pressure 760 torr, LHSV of 42.0 h⁻¹, SiH₄/N₂ volume ratio of 0.1 considering a ratio of SiH₄ and carbon structure, and deposition time of 600 minutes, thus to prepare a silicon-carbon-containing electrode material.

A secondary battery was manufactured according to the same procedures as described in Example 1, except that the silicon-carbon-containing electrode material prepared by the above-described method was used.

Physical properties of the porous carbon structure and silicon-carbon-containing electrode material prepared according to the examples and comparative examples were measured/evaluated as follows.

### (1) Measurement of Total Pore Volume/Volume Ratio of Micropores, Mesopores, and Macropores

The total pore volume and the distribution (volume ratio) of the micropores, mesopores, and macropores in the total pore volume were measured using nitrogen gas adsorption at 77 K by the t-plot method according to the ISO 15901-2 and ISO 15901-3 standards. Specifically, a 3-Flex Adsorption Analyzer, a product of Micromeritics Instrument Corporation, was used.

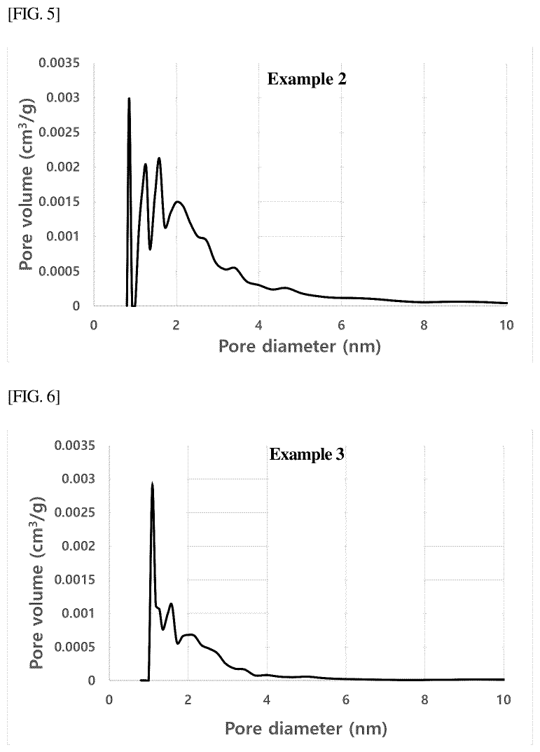

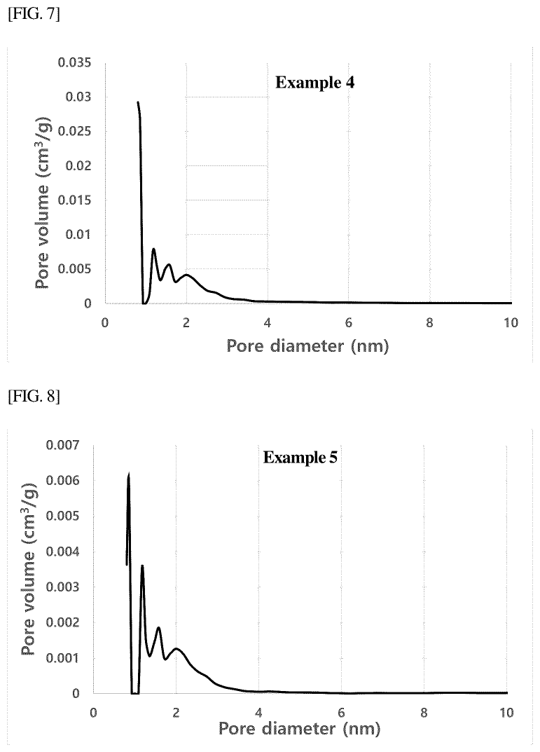

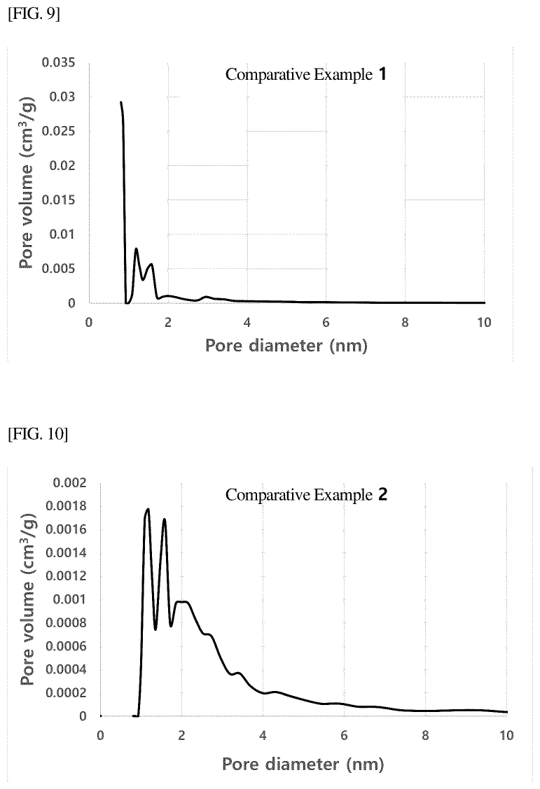

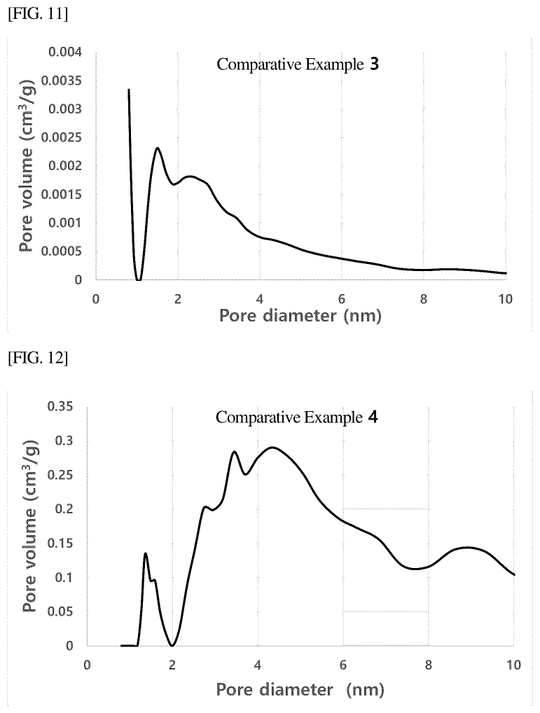

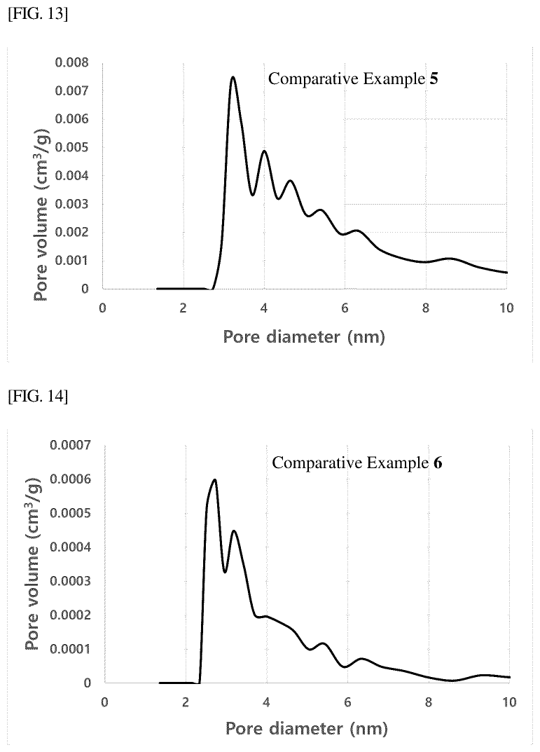

The distribution (volume ratio) of the micropores, mesopores, and macropores in the total pore volumes measured by the above-described method is described in Table 2 below, and measurement results for the silicon-carbon-containing electrode materials according to Examples 1 to 5 and Comparative Examples 1 to 6 are shown as pore distribution graphs in FIGS. 4 to 8 and FIGS. 9 to 14.

### (2) Measurement of Average Pore Size

The pore size of the porous carbon structure was measured using a 3-Flex adsorption analyzer from Micromeritics. Specifically, the pore size of the porous carbon structure was determined by measuring a maximum peak position of the Barrett-Joyner-Halenda (BJH) pore size distribution curve obtained from the nitrogen gas sorption isotherm of porous carbon structure samples used in the examples and comparative examples.

### (3) Measurement of Specific Surface Area

The specific surface area was calculated as a surface area per unit mass by measuring the physical adsorption of gas molecules on the solid surface, according to the ISO 9277 standard using a 3-Flex Adsorption Analyzer system.

### (4) Measurement of Silicon Content

The silicon content in the total weight of the silicon-carbon-containing electrode material was measured using an ICP-OES analyzer. Specifically, the sample was placed into a PP tube, and nitric acid and a small amount of hydrofluoric acid were added thereto and dissolved overnight. After the sample was dissolved, it was stored in a refrigerator, and then the hydrofluoric acid was neutralized with saturated boric acid water and diluted with ultrapure water. Thereafter, the residual carbon was removed with a 0.45 μm syringe filter and analyzed.

(5) Measurement of Peak Intensity Ratio (I_{c-Si}/I_{a-Si}) of Raman Spectral Spectrum

The Raman spectral spectrum of the silicon-containing coating layer was measured using a 532 nm laser Raman analyzer for the silicon-carbon-containing electrode materials prepared according to the above-described examples and comparative examples. In the acquired Raman spectral spectrum, the peak intensity (I_{c-Si}) of the silicon-containing coating layer in a region where the wavelength is 515 nm⁻¹ and the peak intensity (I_{a-Si}) of the silicon-containing coating layer in a region where the wavelength is 480 nm⁻¹ were measured. The measured peak intensities were applied to Equation 1 to calculate the peak intensity ratio (I_{c-Si}/I_{a-Si}) of the Raman spectral spectrum.

(6) Measurement of Ratio of Peak Intensity (I_{D}) in D Band to Peak Intensity (I_{G}) in G Band of the Raman Spectral Spectrum

The I_{D}/I_{G} values for the porous carbon structures included in the silicon-carbon-containing electrode materials prepared according to the above-described examples and comparative examples were measured under the following conditions. Specifically, three points on the surface of the silicon-carbon-containing electrode material were selected, and the I_{D}/I_{G} values were acquired as an average of the corresponding values.
i) Tap density of the silicon-carbon-containing electrode material: 0.99 g/cm³
ii) Electrode density: 1.3 g/cm³
iii) Raman spectrometer: in Via, Renishaw (UK)
iv) Argon ion laser light wavelength: 532 nm
v) Exposure time: 20 seconds, the number of accumulations: 10 times

Results of the physical property evaluation for the porous carbon structures prepared according to the examples and comparative examples are shown in Table 1 below, and the results of the physical property evaluation of the silicon-carbon-containing electrode material prepared according to the examples and comparative examples are shown in Tables 2 and 3 below.

TABLE 1

| | Characteristics of porous carbon structure | | |
|---|---|---|---|
| | Average pore | Specific surface | Total pore volume |
| Item | size (nm) | area (m²/g) | (cm³/g) |
| Example 1 | 1.9 | 2052 | 0.98 |
| Example 2 | 1.9 | 2052 | 0.98 |
| Example 3 | 1.9 | 2052 | 0.98 |
| Example 4 | 1.9 | 2052 | 0.98 |
| Example 5 | 1.9 | 2052 | 0.98 |
| Comparative | 10 | 693 | 0.81 |
| Example 1 | | | |
| Comparative | 10 | 693 | 0.81 |
| Example 2 | | | |
| Comparative | 1.9 | 2052 | 0.98 |
| Example 3 | | | |
| Comparative | 4 | 1657 | 2.06 |
| Example 4 | | | |
| Comparative | 2.5 | 1729 | 1.12 |
| Example 5 | | | |
| Comparative | 2.5 | 1729 | 1.12 |
| Example 6 | | | |

TABLE 2

| | Characteristics of silicon-carbon-containing electrode material | | | | | |
|---|---|---|---|---|---|---|
| | Volume | Volume | Volume | Total | Specific | |
| | ratio of | ratio of | ratio of | pore | surface | Silicon |
| | micropores | mesopores | macropores | volume | area | content |
| Item | (%) | (%) | (%) | (cm³/g) | (m²/g) | (wt %) |
| Example 1 | 61.7 | 36.0 | 2.3 | 0.10 | 48.8 | 40.3 |
| Example 2 | 50.9 | 47.5 | 1.6 | 0.06 | 92 | 76 |
| Example 3 | 58.0 | 32.6 | 9.4 | 0.04 | 62 | 51 |
| Example 4 | 72.7 | 25.6 | 1.7 | 0.16 | 311 | 38 |
| Example 5 | 83.5 | 14.5 | 2.0 | 0.06 | 101 | 48 |
| Comparative | 94.2 | 4.9 | 0.9 | 0.19 | 440 | 47 |
| Example 1 | | | | | | |
| Comparative | 45.8 | 43.3 | 10.9 | 0.10 | 88 | 53 |
| Example 2 | | | | | | |
| Comparative | 34.8 | 61.7 | 3.5 | 0.11 | 143 | 47 |
| Example 3 | | | | | | |
| Comparative | 11.6 | 85.0 | 3.4 | 0.23 | 190.2 | 62.0 |
| Example 4 | | | | | | |
| Comparative | 0 | 96.1 | 3.9 | 0.01 | 16.4 | 62.0 |
| Example 5 | | | | | | |
| Comparative | 0 | 79.2 | 20.8 | 0.01 | 16.6 | 60.5 |
| Example 6 | | | | | | |

TABLE 3

Characteristics of silicon-carbon-containing
electrode material (Raman spectral spectrum)

| Item | I_{c-Si}/I_{a-Si} | I_{D}/I_{G} |
|---|---|---|
| Example 1 | 0.38 | 1.21 |
| Example 2 | 0.40 | 1.22 |
| Example 3 | 0.39 | 1.20 |
| Example 4 | 0.39 | 1.15 |
| Example 5 | 0.39 | 1.09 |
| Comparative | 0.44 | 1.00 |
| Example 1 | | |
| Comparative | 0.48 | 1.20 |
| Example 2 | | |
| Comparative | 0.38 | 1.16 |
| Example 3 | | |
| Comparative | 0.33 | 0.84 |
| Example 4 | | |
| Comparative | 0.52 | 1.19 |
| Example 5 | | |
| Comparative | 0.52 | 1.17 |
| Example 6 | | |

### Experimental Example

The performance of secondary batteries using the silicon-carbon-containing electrode materials prepared according to the examples and comparative examples was measured/evaluated as follows.

### 1. Measurement of Charging and Discharging Capacity

Each of the secondary batteries of the examples and comparative examples was subjected to 0.1 C-rate CC/CV (Constant Current/Constant Voltage) charge (0.01 V, 0.01 C cut-off), and 0.1 C-rate CC discharge (1.5 V cut-off) at 25° C., then the charge and the discharge capacities were measured. More specifically, each battery was charged at a rate of 0.1 times its capacity (C-rate) under constant current until the voltage reached a predetermined value of 4.2 volts. Then charging was transitioned to charging under constant voltage while the current gradually decreased to the low level of 0.01 C.

The discharging process of the battery included a discharge at a constant current rate of 0.1 C. As the battery was discharging, the voltage gradually decreased while maintaining a constant current flow. The discharging process was cut-off when the voltage dropped to 1.5 volts. The entire charging and discharging evaluations were performed at a temperature of 25° C.

### (2) Evaluation of Initial Efficiency

The initial efficiency was calculated by converting a ratio of the discharge capacity to the charge capacity measured in the above (1) into a percentage.

### (3) Measurement of Capacity Retention Rate (Lifespan Characteristics) During Repeated Charging and Discharging

Performing 0.1 C-rate CC/CV charge (0.01 V, 0.01 C cut-off) and 0.1 C-rate CC discharge (1.5 V cut-off) at 25° C. on each of the secondary batteries of the examples and comparative examples were repeated for 50 cycles. The capacity retention rate was evaluated by converting a value divided the discharge capacity at 50th cycle by the discharge capacity at the first cycle into a percentage.

Evaluation results of Experimental Examples 1 to 3 are shown in Table 4 below.

TABLE 4

| | | | | Capacity |
|---|---|---|---|---|
| | Charge | Discharge | Initial | retention rate |
| | capacity | capacity | efficiency | @ 50th cycle |
| Item | (mAh/g) | (mAh/g) | (%) | (%) |
| Example 1 | 2120 | 1929 | 91 | 88.3 |
| Example 2 | 2739 | 2499 | 91.2 | 88.1 |
| Example 3 | 2007 | 1842 | 91.8 | 89.1 |
| Example 4 | 1949 | 1754 | 90.0 | 88.4 |
| Example 5 | 2006 | 1783 | 88.9 | 84.1 |
| Comparative | 1690 | 1032 | 61.1 | 58.5 |
| Example 1 | | | | |
| Comparative | 2008 | 1698 | 84.5 | 77.8 |
| Example 2 | | | | |
| Comparative | 1844 | 1598 | 86.7 | 78.8 |
| Example 3 | | | | |
| Comparative | 1989 | 1655 | 83.2 | 85 |
| Example 4 | | | | |
| Comparative | 2201 | 2032 | 92.3 | 73.9 |
| Example 5 | | | | |
| Comparative | 2006 | 1861 | 92.8 | 70.5 |
| Example 6 | | | | |

Referring to Tables 1 to 4, in the batteries of Examples 1 to 5 manufactured using the silicon-carbon-containing electrode material having a volume ratio of micropores of greater than 50% and less than 90% in the total pore volume, the charge/discharge capacities, initial efficiency, and capacity retention rate were improved compared to the batteries of Comparative Examples 1 to 6 manufactured using the silicon-carbon-containing electrode material having a volume ratio of micropores of less than 50% or greater than 90% in the total pore volume.

### DESCRIPTION OF REFERENCE NUMERALS

100: Cathode
105: Cathode current collector
107: Cathode lead
110: Cathode active material layer
120: Anode active material layer
125: Anode current collector
127: Anode lead
130: Anode
140: Separation membrane
150: Electrode assembly
160: Case

What is claimed is:

1. A silicon-carbon-containing electrode material comprising:
a porous carbon structure; and
a silicon-containing coating layer formed on the porous carbon structure,
wherein a volume ratio of micropores in the porous carbon structure having a pore diameter of 2 nm or less in a total pore volume is greater than 50% and less than 90%.

2. The silicon-carbon-containing electrode material according to claim 1, wherein the volume ratio of micropores in the porous carbon structure having a pore diameter of 2 nm or less in the total pore volume is 55% to 80%.

3. The silicon-carbon-containing electrode material according to claim 1, wherein the volume ratio of mesopores having a pore diameter of greater than 2 nm and less than 50 nm in the total pore volume is 8% to 48%, and the volume ratio of macropores having a pore diameter of greater than 50 nm is 1.5% to 10%.

4. The silicon-carbon-containing electrode material according to claim 1, wherein the total pore volume is 0.02 cm³/g to 0.2 cm³/g.

5. The silicon-carbon-containing electrode material according to claim 1, wherein a ratio of the total pore volume of the silicon-carbon-containing electrode material to a total pore volume of the porous carbon structure is 0.15 or less.

6. The silicon-carbon-containing electrode material according to claim 1, wherein the electrode material has a specific surface area of 60 m²/g to 320 m²/g.

7. The silicon-carbon-containing electrode material according to claim 1, wherein a ratio of a specific surface area of the silicon-carbon-containing electrode material to a specific surface area of the porous carbon structure is 0.1 or less.

8. The silicon-carbon-containing electrode material according to claim 1, wherein a content of silicon in the total weight of the silicon-carbon-containing electrode material is 30% by weight to 80% by weight.

9. The silicon-carbon-containing electrode material according to claim 1, wherein a peak intensity ratio of Raman spectral spectrum measured from the silicon-containing coating layer defined by Formula 1 below is 0.5 or less:
Peak intensity ratio of Raman spectral spectrum=I_{c-Si}/I_{a-Si} Formula 1
(in Formula 1, I_{c-Si} is a peak intensity of the silicon-containing coating layer in a region where a wavelength is 515 nm⁻¹ in the Raman spectral spectrum, and I_{a-Si} is a peak intensity of the silicon-containing coating layer in a region where the wavelength is 480 nm⁻¹ in the Raman spectral spectrum).

10. The silicon-carbon-containing electrode material according to claim 1, wherein a ratio of a peak intensity (I_{D}) in a D band to a peak intensity (I_{G}) in a G band of the Raman spectral spectrum obtained from the porous carbon structure is 1 to 1.3.

11. A method for preparing a silicon-carbon-containing electrode material, the method comprising:
forming a polymer precursor solution;
forming a polymer gel by polymerizing a polymer precursor included in the polymer precursor solution;
forming a bulk carbon structure by drying and carbonizing the polymer gel;
forming porous carbon structures by pulverizing the bulk carbon structure; and
forming a silicon-containing coating layer on the porous carbon structures to obtain a silicon-carbon-containing electrode material,
wherein a volume ratio of micropores in the porous carbon structure having a pore diameter of 2 nm or less in a total pore volume of the silicon-carbon-containing electrode material is greater than 50% and less than 90%.

12. The method according to claim 11, wherein the silicon-containing coating layer is formed through a deposition process under conditions of a temperature of 400° C. to 800° C. and a pressure of 700 torr to 800 torr.

13. The method according to claim 12, wherein the deposition process includes supplying a silicon precursor and a carrier gas, and a ratio of a flow rate of the silicon precursor to a flow rate of the carrier gas is 1/50 to 1/3.

14. A lithium secondary battery comprising:
an anode which comprises the silicon-carbon-containing electrode material according to claim 1; and
a cathode disposed to face to the anode.

15. A lithium secondary battery comprising:
a silicon-carbon-containing electrode material comprising:
a porous carbon structure; and
a silicon-containing coating layer formed on the porous carbon structure,
wherein a volume ratio of micropores in the porous carbon structure having a pore diameter of 2 nm or less in a total pore volume is greater than 50% and less than 90%,
wherein a ratio of a specific surface area of the electrode material to a specific surface area of the porous carbon structure is 0.1 or less.
